(19) United States
(12) Patent Application Publication
(10) Pub. No.: US 2009/0316436 A1
(43) Pub. Date: Dec. 24, 2009

(54) Gaming machine

(75) Inventors: Katsumi Takahashi, Las Vegas, NV (US); Takashi Nishitsuji, Las Vegas, NV (US); Hidekazu Kato, Las Vegas, NV (US)

Correspondence Address: MASUVALLEY & PARTNERS, 8765 AERO DRIVE, SUITE 312, SAN DIEGO, CA, 92123, US

(73) Assignee: Konami Gaming, Inc., Las Vegas, NV (US)

(21) Appl. No.: 12/215,114

(22) Filed: Jun. 24, 2008

(51) Int. Cl. F21V 8/00; A63F 9/00

(52) U.S. Cl. 362/628; 463/31

(57) ABSTRACT

The present invention is a gaming display using a gaming display including a light guide plate having at least two flat surfaces, and a light emit member for emitting light to the light guide plates, wherein the light guide plate is sectioned by a groove for avoiding interference of light from the light emit member. Besides, the present invention is a gaming display including a light guide plate having at least two flat surfaces, and a light emit member for emitting light to the light guide plates, wherein the light guide plate is sectioned by a light shielding member for blocking light to enter another section of the light guide plate.

### TECHNICAL FIELD

The present invention relates to a gaming display (wheel) used for gaming machines. The gaming display pertaining to the present invention is divided into a plurality of sections, and it is arranged to shield or block light between respective sections.

### BACKGROUND OF THE INVENTION

Various kinds of wheels are attached to a gaming machine used in a casino. These wheels are divided into a plurality of sections. Any one of sections is selected among these sections. According to the display drawn on these sections, prize is paid out to a player or a game advances. These wheels have been popular among casino players over the past, and it still continues to gain popularity. These wheels are described, for example, in U.S. Pat. No. 7,048,631. U.S. Pat. No. 7,048,631 discloses a wheel, which allows a groove side face to emit lights by using refracted light at the boundary of a transparent component and air. Although various wheels have been provided to the casino players, at the same time, emergence of a more novel wheel has been desired.

### SUMMARY OF THE INVENTION

An aspect of the present invention is a gaming display using a gaming display including a light guide plate having at least two flat surfaces, and a light emit member for emitting light to the light guide plates, wherein the light guide plate is sectioned by a groove for avoiding interference of light from the light emit member.

By configuring as mentioned above and by making groove or space between respective sections, an interference of light between respective sections can be prevented. By configuring so, light irradiated to each section will not leak from the section to anther section, and it is possible to allow the section to emit light more clearly. In addition, since what is provided between respective sections is space or groove, an appearance to a player can also be simple while contributing to manufacturing cost reduction of gaming displays.

The gaming display of claim may be configured by stacking at least two light guide plates.

By having a gaming display capable of using not only one plate but also a plurality of plates, a game, which is rich in variety, can be provided to a player. Although the amount, which can be displayed on one plate, is limited, more variety of displays can be used in a game by using a plurality of plates.

The gaming display may be constructed to be able to light up one or more light guide plates among at least two light guide plates.

By configuring as mentioned above, since it is not only possible to use a plurality of plates and expand the number of display used during the game, but it is also possible to manipulate the plate to be lit, a game having a variety of displays can be provided to a player.

A character or a number is written on the light guide plate, wherein the character or the number within a range, where light from the light emit member is guided, is arranged to appear, and wherein the character or the number written on each of the light guide plate is difference from each other.

A picture is written on the light guide plate, wherein the picture appears within a range, where the light from the light emit member is guided, is arranged to appear, and wherein the picture written on each of the light guide plate is difference from each other.

A plurality of characters or numbers is written on the light guide plate by different materials from each other so that the characters or the numbers appearing within range where the light is guided change according to a kind of emitted light from the light emit member.

By configuring the gaming display as above, even if the display is drawn on the same section on the plate, shape or color of the display visible to a player may be changed by the difference in the wavelength of light applied to the section. Therefore, for example, there may be cases when a red symbol is displayed or when a blue symbol is displayed on the same section, and a game having a wide variety of richness can be provided to a player.

The flat surface onto which emitted light is irradiated is roughened. By configuring the gaming display as above, incident light guided into the plate is diffusely reflected by the roughed surface, and the entire plate or each section can emit light more clearly by the reflected light. And a more clear display can be provided to a player.

The light emit member may be a light-emitting diode. By configuring the gaming display as above, the entire plate or each section can emit light more clearly, and the color of irradiating light can be changed.

Another aspect of the present invention is a gaming display including a light guide plate having at least two flat surfaces, and a light emit member for emitting light to the light guide plates, wherein the light guide plate is sectioned by a light shielding member for blocking light to enter another section of the light guide plate.

By configuring the gaming display as described above and providing a light shielding member between respective sections, the interference of light of each section can be prevented. By configuring as above, it is possible to make the section emit light more clearly without the light irradiated to each section leaking from the section. Furthermore, since the light shielding member reflects light back into the plate, each section can emit light stronger.

The light emit member is arranged to emit light to a selected light guide plate.

By configuring as above, the entire plate or each section can emit light more clearly, and color of irradiating light can be changed.

The light emit member may be placed around the light guide plate.

By arranging the light emit member on the circumference of the plate, it is possible to irradiate the plate more efficiently.

The light guide plate may have a space in the middle of the guide plate and the light emit member is placed in the space.

By providing the light emit member in the space made in the center of the plate, each section can be irradiated from both inside and outside, and each section can emit light more effectively.

The gaming display may have a plurality of light emit members and a light emit member of the plurality of the light emit members sequentially emits light to indicate a selected section of the light guide plate by moving a position from which light is emitted across the plurality of light emit members.

By configuring the gaming display as described above, various methods for selecting each section on the plate can be provided. Based on the above-mentioned configuration, the game becomes richer in variety.

The light emit member may be a light-emitting diode. The light guide plate may be a light guide wheel.

Another aspect of the present invention is a gaming display employing a substrate including a light guide element, the gaming display including a plurality of areas provided on the substrate, which has at least one surface, a light shielding member or a space between the areas, and a code, a character or a number drawn in the area.

By configuring the gaming display as described above and providing the light shielding member or space between respective sections, the interference of light of each section can be prevented. By configuring the gaming display as described above, it is possible to allow the section to emit light more clearly without the light irradiated to each section leaking from the section. Furthermore, since the light shielding member reflects light back into the plate, each section can emit light stronger. In addition, when the space is provided between respective sections, while contributing to manufacturing cost reduction of gaming displays, appearance from a player can also be made simple.

The substrate may be a wheel. The gaming display may have a tool for indicating a selected area of the plurality of areas.

By configuring the gaming display as above, various methods for selecting each section on the plate can be provided. Based on the above-described configuration, a game becomes richer in variety.

The gaming display may be utilized on a bonus game or a secondary game.

### BRIEF DESCRIPTION OF THE DRAWINGS

FIG. 1 illustrates a perspective diagram showing an example of a gaming machine of the present invention.

FIG. 2 illustrates a figure showing an example of a gaming display pertaining to the present invention.

FIG. 3 illustrates a figure showing an example of a gaming display configured by two plates.

FIG. 4 illustrates a figure showing an example of a game method using the gaming display pertaining to the present invention.

FIG. 5 illustrates a figure showing an example of a gaming display, which conducts a display using a paint material, which reacts to a specific wavelength.

FIG. 6 illustrates a figure showing an example of a selection method of a section on a gaming display.

FIG. 7 illustrates a figure showing an example of a selection method of a section on a gaming display.

FIG. 8 illustrates a figure showing an example of a selection method of a section on a gaming display.

FIG. 9 illustrates a figure showing an example of a configuration of a whole gaming display.

FIG. 10 illustrates a figure showing an example of a configuration of a whole gaming display.

FIG. 11 illustrates a flowchart of an operation process of a gaming display.

### DETAILED DESCRIPTION OF THE INVENTION

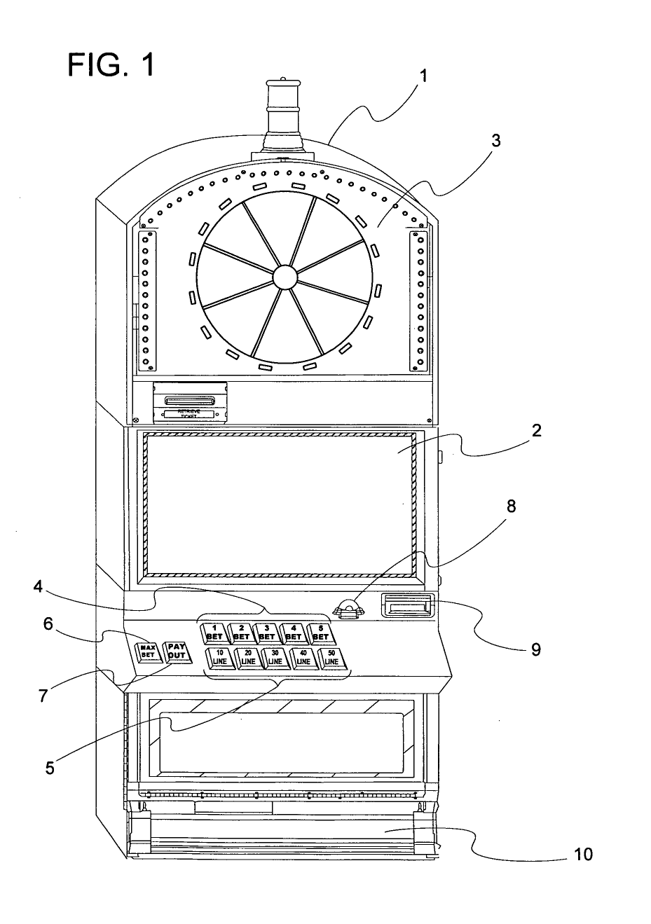

FIG. 1 illustrates a perspective diagram showing an example of a gaming machine of the present invention. As shown in FIG. 1, a gaming machine 1 is provided with a display 2 and a gaming display 3. Immediately under the display 2, provided are a BET switch 4, a SELECT switch 5, a MAXBET switch 6, a PAYOUT switch 7, a coin slot 8 and a bill slot 9. The BET switch 4 has five switches from 1BET to 5BET. The SELECT switch 5 has five switches from 1select to 5select. In addition, a coin pay out slot 10 is provided in the lower part of the gaming machine 1.

On the display 2, a display required for a player to play a game is displayed. For example, on the display 2, a display for performing a primary game or a secondary game is displayed. On the display 2, for example, cards used in a card game, roulette and a coin used in a roulette game, a reel used in a reel game or a feature is displayed. In addition, a display for a player to select a kind of a progressive game or a bonus game, and a display for a player to select a feature are also displayed on the display 2. In addition, on the display 2, a progressive screen, which displays an amount that player can win, may be displayed. In addition, on the display 2, a representation corresponding to progress status of a game, a credit inputted to a gaming machine by a player, or a play history of the player may be displayed. On the other hand, the gaming display 3, for example, is wheel-shaped, and a character or a number may be displayed in each section on the wheel. The gaming display 3 may be used in any ways. For example, the gaming display 3 can be used in a bonus game.

The BET switch 4 is a switch for inputting a bet amount for a game. A player is able to input a bet amount from 1BET to 5 BET using the BET switch 4 in one game. The SELECT switch 5, for example, is a switch for selecting a card, which a player wants to discard, and for selecting a line on a reel. A number of the BET switch 4 and the SELECT switch 5 may not be limited to five each, but may be any number. In addition, the gaming machine 1, for example, may have a switch for betting 10BET and may have a switch of 10 SELECT.

The MAXBET switch 6 is a switch for a player to input the maximum bet for one game. The PAYOUT switch 7 is a switch for paying out to a player an amount credited in a gaming machine. The coin slot 8 is a hole for a player to credit coins to a gaming machine. The bill slot 9 is a hole used to input a bill or a cash card to a gaming machine, or used to pay out a credited amount. The coin pay out slot 10 is for paying out amount that has been credited in a gaming machine to a player.

The gaming machine pertaining to the present invention is not limited to the above-mentioned gaming machine, but may be provided with other various functions, and the above-mentioned function may be omitted. For example, a lighting device for lighting a gaming machine using not less than one color in case when a player proceeds into a secondary game may be provided on the gaming machine. A device for reproducing music and a device for vibrating the whole gaming machine in case when a player proceeds into the secondary game may be provided on the gaming machine. In addition, the gaming machine 1 may have three or more displays. The gaming machine 1 may have a switch for player to re-select the BET, which the player selected in the last game.

In addition, a reel and a roulette used in a game do not need to be displayed on a display, and a stepper (mechanical reel) and a mechanical roulette may be mounted on the gaming machine 1. In addition, a display, which is commonly used by a plurality of gaming machines, may exist. In addition, a position of components (the display 2 and the gaming display 3) of the above-mentioned gaming machine may not be particularly limited, but may be arranged in any position. For example, the position of the display 2 and the gaming display 3 on the gaming machine 1 may be reversed. In addition, a common installation portion of a plurality of gaming machines may be separately provided and the gaming display 3 may be provided on the common installation portion.

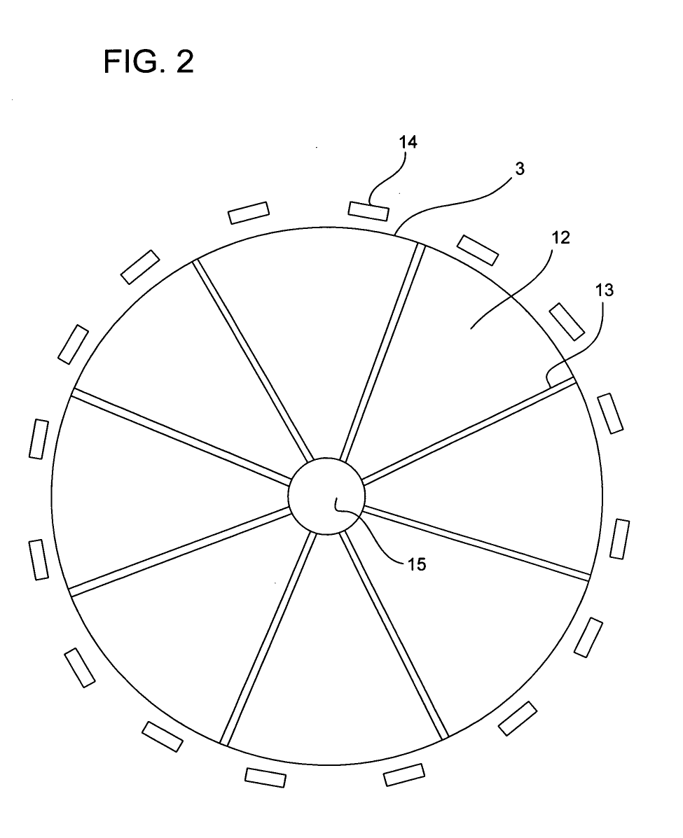

Next, the above-mentioned gaming display 3 will be explained in detail. FIG. 2 illustrates a figure showing an example of a gaming display pertaining to the present invention. The gaming display 3 is shown in FIG. 2. The gaming display 3 is configured by a light guide plate 12 and a light emit member 14. A light guide plate 12 has a plurality of sections. A backside of the light guide plate 12 may be made into rough surface in order to diffusely reflect the light. A character, a symbol, a number and a picture may be displayed on each section. A plurality of the light emit members 14 is provided around the light guide plate 12.

The light emit member 14 is provided to irradiate the light guide plate with light. When the light emit member 14 irradiates lights towards the light guide plate 12, since the light guide plate 12, for example, is configured by a transparent member, the irradiated light incidents into the light guide plate 12. And the incident light is diffusely reflected to the backside of the plate 12 whose surface has been roughed, and the light is reflected towards the front surface of the plate. Thus, each whole section on the plate can emit light more clearly. Since color of the light emitted by the light emit member 14 is not particularly limited and capable of emitting any color of light, for example, it is possible to emit a red light and allow a certain section to emit a red light. In addition, since a different color of light is emitted for every section when the color of irradiating light is changed for each section, partition on the plate can be seen clearly by a player.

In addition, between respective sections, for example, a space or a light shielding member is provided as a device for preventing incidence of light. By this configuration, the light irradiated to each section is reflected by the light shielding member. Since the incident light is totally reflected (total internal reflection) within each section, interference of light between adjacent sections can be prevented without the incident light leaking to other sections. As a result, it is possible to make only the irradiated section conspicuous and emit light. Furthermore, by total reflection luminescence within the section makes it possible to display, such as a number drawn or written on the section, clearer. In addition, by configuring as above, only a display of a section, which is intended to be visible to a player, can be clearly displayed to the player by the irradiated light. For example, in case when a section on a gaming display is divided into A-F, only the character shown in section A can clearly be visible to a player, and a situation where the characters shown in the other sections B-F are not visible to a player can be created.

A shape of a gaming display does not need to be a wheel-shaped and may be in any shape. For example, the shape of a gaming display may be a symmetrical shape such as a square-shaped, diamond-shaped, or hexagon. In addition, the shape of a gaming display may not be a symmetrical shape, but a figure onto which a heart-shaped, a spade-shaped, a star-shaped or a character is drawn, for example. In addition, a gaming display may be in a plate form, which has two parallel sides, or a three-dimensional shape such as a diamond. In addition, a gaming display may be a cone-shaped where a central part 15 is perpendicularly projected to the plate.

In addition, a number of sections provided on a gaming display may be any number. For example, the section of the gaming display may greatly be divided into four, and may be finely divided into the section of one hundred. The surface of each section may be even or uneven. In addition, the number of light emit member may be any number. In FIG. 2, although two light emit members are provided for each section, number of light emit member provided for each section may be any number and number of light emit member provided for each section may differ for every section. In addition, the position, at which light emit member is provided, does not need to be on the circumference of the light guide plate. For example, the light emit member may be provided on the opposite side of the light guide plate, which is to be seen by a player, and may be used as a backlight for irradiating the plate. In addition, for example, the light emit member may be provided on the light guide plate so as to contact thereon, or may be provided in the central part 15. In addition, the central part 15 does not need to exist.

As long as a material of the light guide plate transmits light, the material may be any kind, for example, an acrylic resin. Although an acrylic resin is generally an amorphous synthetic resin with high transparency, the acrylic resin may have a low transparency containing impurities. Also in an acrylic resin, for example, it is desirable to use a transparent solid material (acrylics glass) with methyl methacrylate resin (PMMA). The degree of polymerization by a radical polymerization of the acrylic resin, for example, is desirable at about 10,000 to about 15,000. As for a formation method of the light guide plate, for example, a method of a heat plasticization formation using a product made from a suspension polymerization of acrylic ester or the methacrylate ester may be listed. Other than this, as for the quality of the material of light guide plate, for example, a polycarbonate (PC), ABS resin (ABS) and polyacetal resin (POM) are mentioned.

In addition, as long as the light emit member is a member, which emits light, it may be any kind of member, for example, it may be light-emitting diode (LED), or a Cold-Cathode Fluorescent Lamp (CCFL). In addition, as long as the material of the light shielding member is capable of shielding light, the material may be any kind regardless of plastic, metal, or wood. In addition, the width of the space provided between the above mentioned sections is not particularly limited. As long as there is enough width to prevent the invisibility of the characters displayed on the section from a player by the light leaking to an adjacent section from a certain section, the width may be any width. For example, the distance between respective sections may be about 0.5 mm-4 cm, and is desirable at about 1 cm-2.5 cm. In addition, the display generated on each section may be conducted using, for example, clear paint. In addition, the shape of each section on a gaming display may not be a sector form as shown in FIG. 2, but may be in any shape. For example, the shape of each section may be a rectangle.

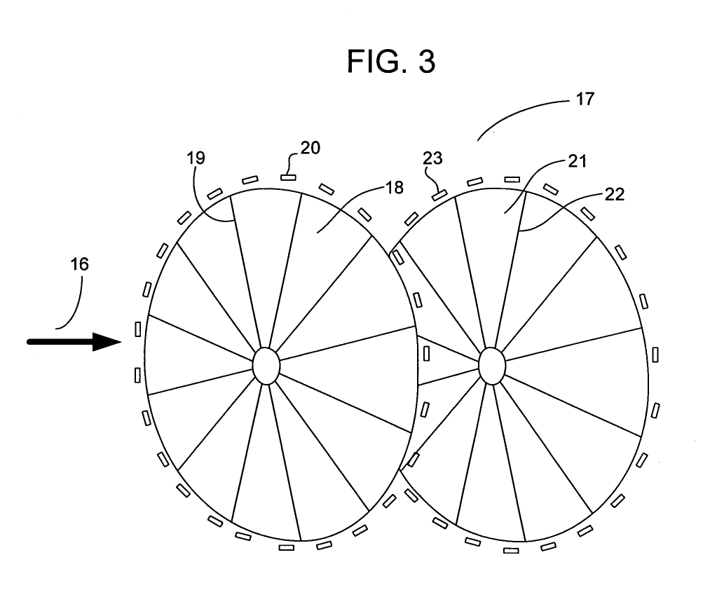

Next, a case where the gaming display is configured by a plurality of plates will be explained. FIG. 3 illustrates a figure showing an example of the gaming display configured by two plates. A gaming display 17 is shown in FIG. 3. The gaming display 17 is configured by two sheets of light guide plates 18 and 21, and light emit members 20 and 23. The light emit member 20 is used for irradiating the light guide plate 18. On the other hand, the light emit member 23 is used to irradiate a light guide 21. The light guide plate 18 has a plurality of sections. The space or the light shielding member 19 is provided between respective those sections. The light guide plate 21 is configured the same as the light guide plate 18.

For example, in case when the player looks at the plates in the same direction as an arrow 16 is pointing, only a display drawn on the plate 18 is visible to the player since only the plate 18 is irradiated by the light emit member 20. On the other hand, it is also possible to make only the display drawn on the plate 21 visible from a player by having the light emit member 23 irradiate only the plate 21. In addition, for example, it is possible to make only the display on the section of plate 21 and 18 visible from a player by having the light emit member 23 irradiate a predetermined section on plate 21 while having the light emit member 20 irradiate only a predetermined section of the plate 18. For example, since this plate is configured by a transparent material, the display drawn on the plate 21 is visible from the player even if the plate 21 is provided in the back side when seen from the player and is provided behind the plate 18.

A number of plates configuring the gaming display pertaining to the present invention may be any number. For example, the gaming display may be configured by three plates. In addition, the surface areas of a plurality of plates configuring the gaming display may differ. In addition, the gaming display may be configured by a plurality of various shapes of plates. When the shapes of the plates are different, it is possible to provide a player with a different display every time when the plate onto which light is irradiated changes.

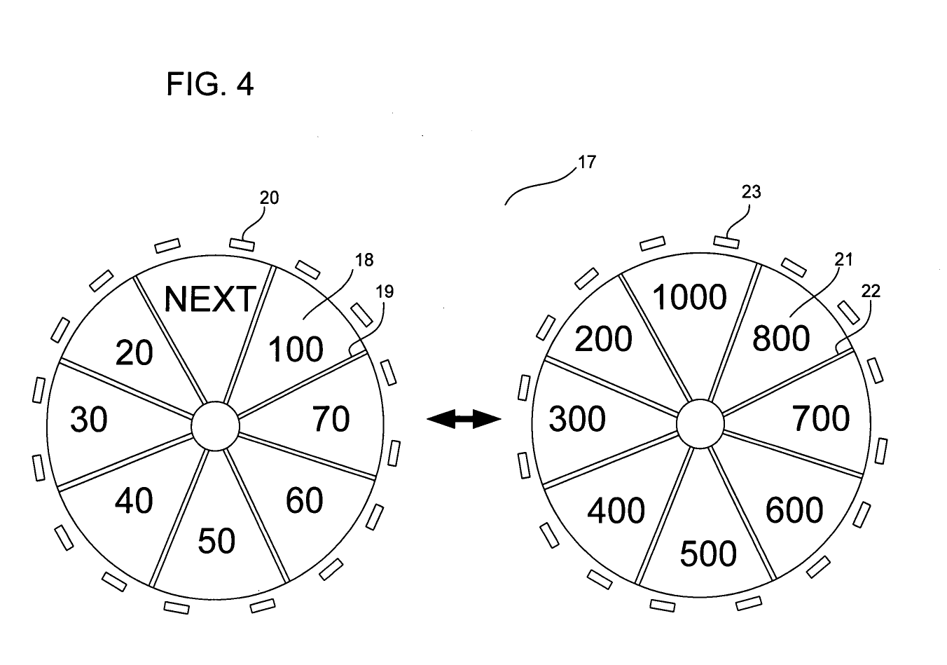

Next, an example of a game method using a plurality of plates will be explained. FIG. 4 illustrates a figure showing an example of a game method using the gaming display pertaining to the present invention. Two plates shown in FIG. 3 are shown in FIG. 4, and a number is displayed on each plate. The gaming display 17, which is configured by two plates 18 and 21, is shown in FIG. 4. On the plate 18, the display of numbers, such as “100”, and of “NEXT” are shown. On the plate 21, number, such as “1000”, is shown. In FIG. 4, first, one of the section on the plate 18 is irradiated by the light emit member 20, then the irradiated section changes as time elapses. That is, for example, the display visible from the player changes as the display “20” is irradiated at first, then the display “NEXT” is irradiated next. And finally one of the section on the plate 18 is selected. When the selected display is a number, a credit or a score of that number may be added to the player. On the other hand, when the selected display is “NEXT”, a light irradiation to one of the section on the plate 21 may be started by the light emit member 23. And the irradiation is performed as in the explanation of the plate 18, and finally, one of the sections on the plate 21 is selected. And a credit and a score of that number may be added.

There is no restriction for what would be displayed on each section of the gaming display pertaining to the present invention. For example, a picture, such as a symbol and a number and/or a picture, such as a character, a letter and a character, a color, ratio and/or number of gaming hours may be displayed on each section. For example, when a predetermined number of gaming hours on the section is selected, a predetermined game may be performed only for the selected hours. In addition, for example, when a predetermined ratio on the section is selected, an amount of a predetermined credit multiplied by the selected ratio may be paid out to a player.

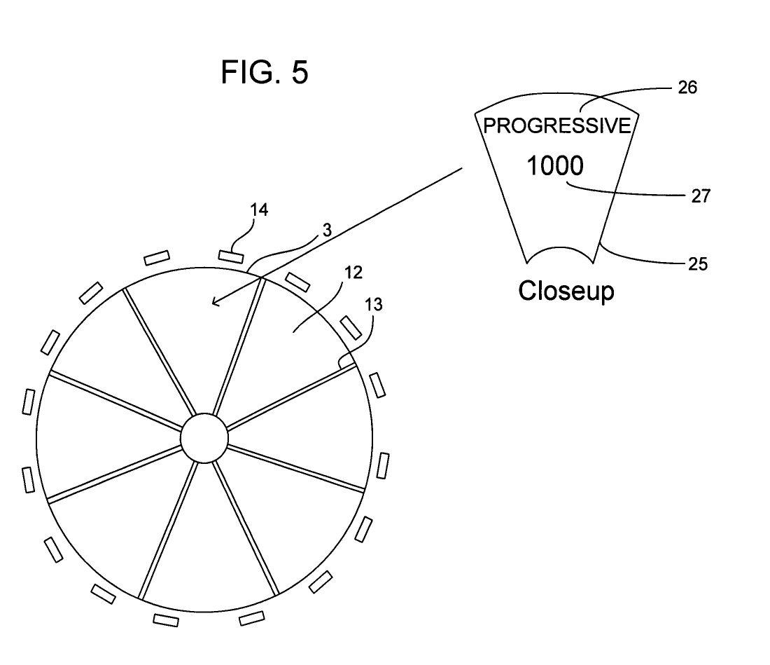

Next, a case where a gaming display displays using a paint material, which is reactant to a specific wavelength, will be explained. FIG. 5 illustrates a figure showing an example of the gaming display, which is displayed by using a paint material, which is reactant to a specific wavelength. The gaming display 3 is shown in FIG. 5. The gaming display 3 is configured by a light guide plate 12 and a light emit member 14. The light guide plate 12 has a plurality of sections. Space, groove or a light shielding member 13 is provided between respective sections. A section 25 is a close-up view of one section on the gaming display 3.

The “PROGRESSIVE” display 26 and the “1000” display 27 are shown in the section 25. These “PROGRESSIVE” and “1000” are drawn with paint materials, which respectively reacts to a different wavelength. Therefore, for example, when a light having a specific wavelength A is irradiated to section 25, a “PROGRESSIVE” display 26 becomes visible to a player, however, it is possible to make a situation where “1000” display 27 is not visible to a player. In contrast with this, it is also possible to make only the “1000” display 27 is visible from the player when a light having a specific wavelength B is irradiated to the section 25. In this case, for example, when “PROGRESSIVE” is displayed, a blue “PROGRESSIVE” is visible to a player, on the other hand, when “1000” is displayed, a red “1000” may be visible for a player. Adjustment of the wavelength of the light irradiated to the plate, for example, may be conducted by the light emit member itself, or an apparatus for adjusting the wavelength, which may separately be provided. In addition, the color visible to a player is not limited to red and blue, but may also be any color, such as purple. In addition, a display is not limited to “PROGRESSIVE” and “1000”, either.

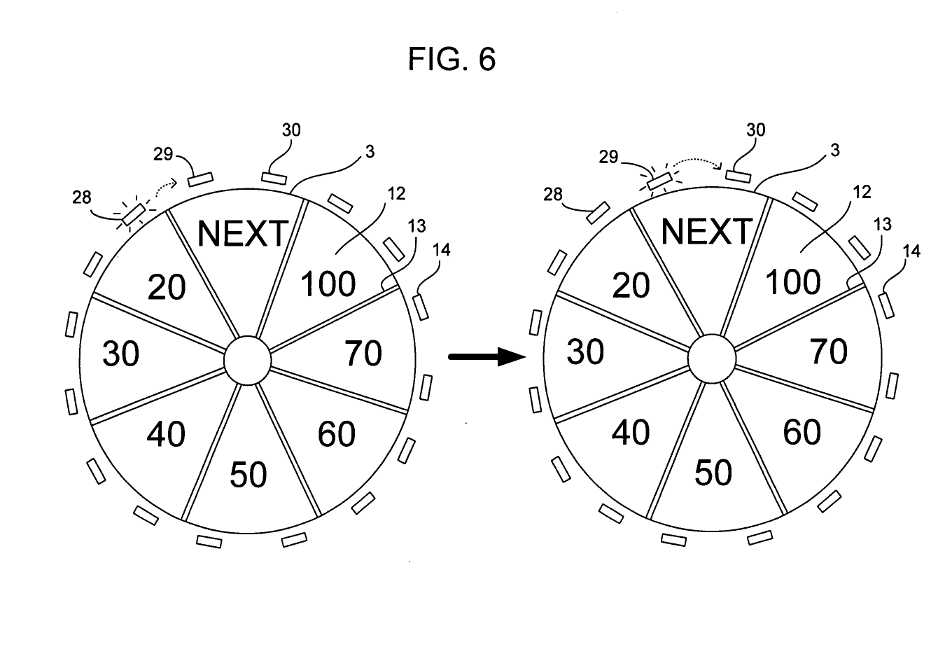

Next, a selection method of a section on a gaming display will be explained. FIG. 6 illustrates a figure showing an example of the selection method of the section on a gaming display. The gaming display 3 is shown in FIG. 6. The configuration of this gaming display is the same as the above described. In FIG. 6, a plurality of light emit members 14 is provided and these light emit members sequentially light up in the order as time elapses. It looks as if the light is moving on each light emit member from the player. And it means that the section corresponding to the position at which light finally stopped was selected. The gaming display 3 on the left-hand side of FIG. 6 shows the preceding state of light moving on the light emit member. On the other hand, the gaming display 3 on the right-hand side of FIG. 6 shows a state after light source has moved on the light emit member. On the gaming display 3 on the left-hand side of FIG. 6, the light emit member 28 is lit. As a following stage, the light emit member 29 lights up as shown on right-hand side of FIG. 6. And next, the selection of the section is performed in such a way that the light emit member 30 lights up.

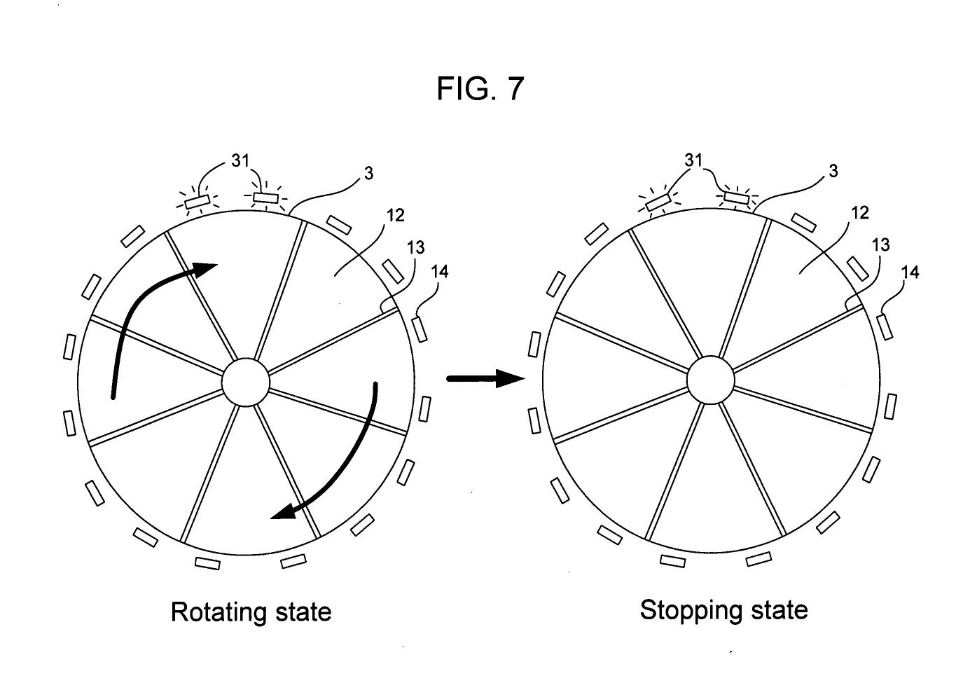

Next, another example of this selection method will be explained. FIG. 7 illustrates a figure showing an example of a selection method of the section on a gaming display. The gaming display 3 is shown in FIG. 7. The configuration of this gaming display is the same as the above described. The light emit member 31 is lit in FIG. 7. As explained in FIG. 6, a light source of the light emit member does not shift, but the light source of the light emit member stays at the position shown in the FIG. 7 here. And in FIG. 7, one of the sections is selected by the rotation of the plate 12. That is, the plate 12 stops after the rotation, and a section of the plate 12 is selected when the plate 12 has stopped at the place where a light emit member is lit.

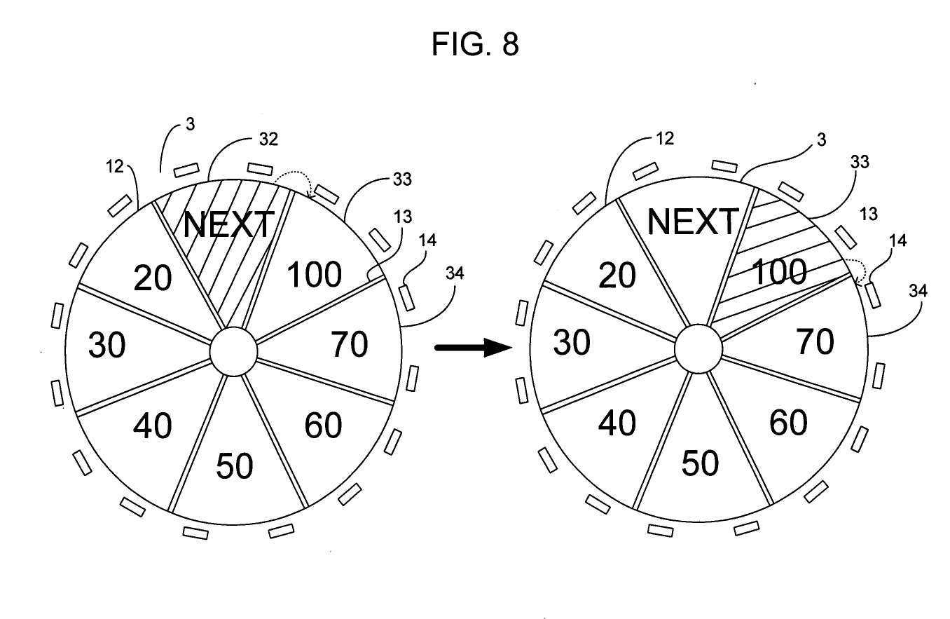

Next, another example of this selection method will be explained. FIG. 8 illustrates a figure showing an example of the selection method of the section on a gaming display. The gaming display 3 is shown in FIG. 8. A configuration of this gaming display is the same as the above-mentioned configuration. In FIG. 8, a selection method by which the section itself lights up by a backlight and the lit section will change as time elapses. The gaming display 3 on the left-hand side of FIG. 8 shows the state before this light source moves. The gaming display 3 on the right-hand side of FIG. 8 shows the state after this light source has moved. Thus, this light source moves on the sections and the position where the light source stops is going to be the selected position.

Although the examples of selection method of the section on the gaming display was explained in the above-mentioned FIGS. 6-8, the selection method is not limited to those, but may be any other selection method. For example, selection parts, such as an arrow or a ball, may be provided in a central part or on the circumference of the gaming display. Then a predetermined section on the gaming display may be selected by moving these selection parts. In addition, a predetermined section on the gaming display may be selected by these selection parts stopping and rotation of the plate.

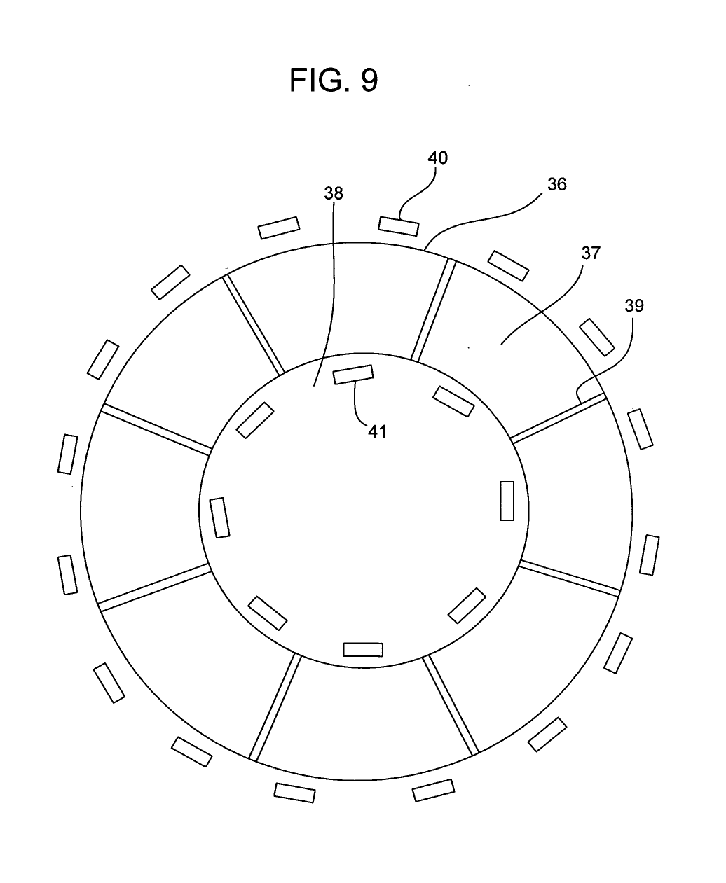

Next, a configuration of the whole gaming display pertaining to the present invention will be explained with an example. FIG. 9 illustrates a figure showing an example of a configuration of the whole gaming display. A gaming display 36 is shown in FIG. 9. The gaming display 36 is configured by a light guide plate 37 and light emit members 40 and 41. The light guide plate 37 has a plurality of sections. A light shielding space or groove, or a light shielding member 39 is provided between respective sections. The gaming display 36 has a central part 38, and light emit member is provided on circumference of the gaming display and in the central part 38. For example, by arranging light emit members also in the central part, it is possible to make each section emit light more clearly. Since it is also possible to select the section by the light emit member of the gaming display circumference and, at the same time, by the light emit member of central part 38, for example, it is also possible to select two sections using two means of light emit members on the circumference and the center.

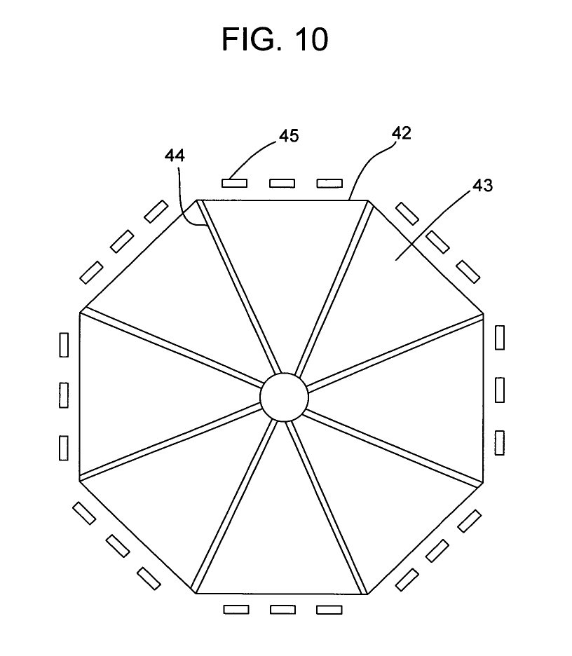

FIG. 10 illustrates a figure showing an example of a configuration of the whole gaming display. A gaming display 42 is shown in FIG. 10. The gaming display 42 is configured by a light guide plate 43 and a light emit member 45. The light guide plate 43 has a plurality of sections. A light shielding space, groove or a light shielding member 44 is provided between respective sections. The gaming display 42 has an octagon-shaped.

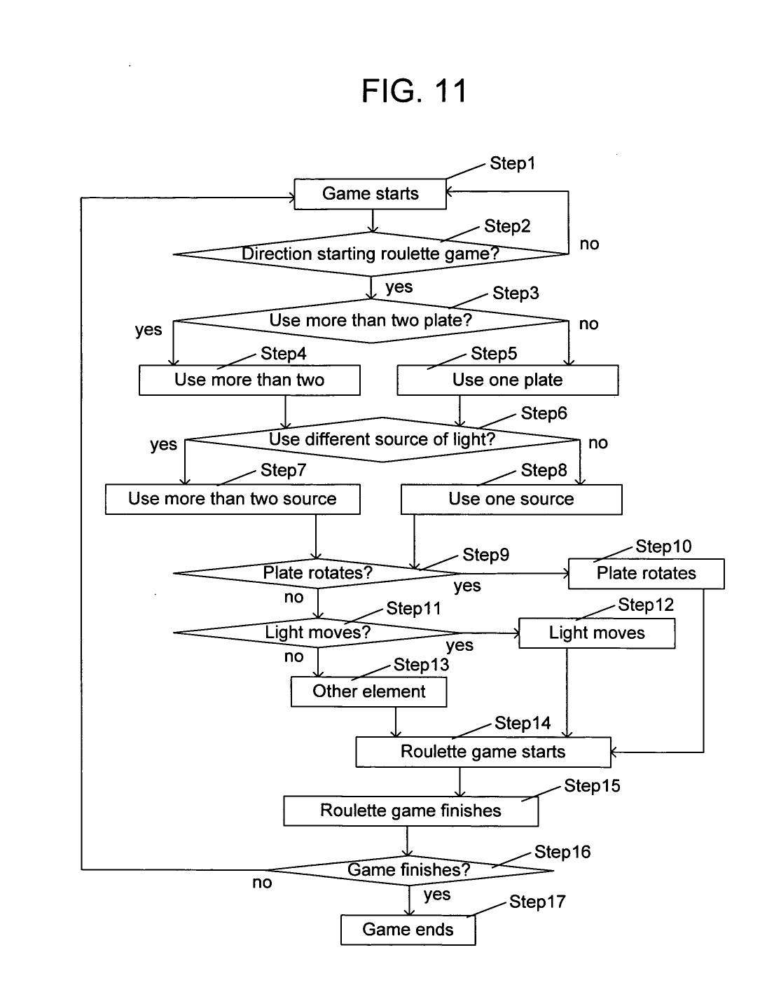

Next, an operation process of the gaming display pertaining to the present invention will be explained. FIG. 11 is a flow chart of the operation process of the gaming display. In this operation process, first, a game starts with a gaming machine (Step 1). And whether there was an operation instruction of the gaming display during the game or not is determined (Step 2). When there is no operation instruction, the above-mentioned game continues. When there is an operation instruction of a gaming display, whether a plurality of plates is going to be used or not is determined (Step 3). When it is determined that a plurality of plates is going to be used, a plurality of plates is prepared (Step 4). On the other hand, when it is determined that one plate is going to be used, one plate is prepared (Step 5).

When a number of plates of the gaming display is determined, whether a plurality of kinds of light source is going to be used or not is determined next (Step 6). When it is judged that a plurality of kinds of luminous sources are to be used, it is determined the use of a plurality of kinds of luminous sources (Step 7). On the other hand, when it is judged that only one kind of light source is going to be used, usage of one kind of light source is determined (Step 8). When the light source, which is going to be used, is determined, a method for selecting a section on a plate is determined next. First, whether a plate is going to be rotated in order to select a section or not is determined (Step 9). When a plate is determined to be rotated (Step 10), a roulette game starts (Step 14). If a plate is not being rotated, whether moving a light source or not is determined (Step 11). When the removal of the light source is determined (STEP 12), a roulette game starts (Step 14). If a light source is not being removed, other section selection methods are determined (Step 13), and a roulette game starts (Step 14). When a roulette game is executed, the above-mentioned determined items operate. And when a roulette game ends (STEP 15), whether the game in the whole gaming machine is complete or not is determined (Step 16). A game will resume when this game is determined not complete (Step 1). On the other hand, a game will end when this game is determined to be completed (Step 17).

In addition, in the above-mentioned flow chart, the processes of determining the number of plates to be used exist (Steps 3-5). However, a number of plates, which is already set in the game machine beforehand, may be used as is without the existence of those processes. In addition, the light source and the selection method set beforehand may be used without the process of determining the kind of light source to use (STEP 6-8) or the process of determining the selection method of section (STEP 9-13) existing. In addition, the selection method of section does not need to be only one kind. For example, the section may be selected by both methods of moving the light source and rotation of the plate.

In the above, the present invention was concretely explained using a flow chart and a plurality of figures. However, those are just specific examples and the present invention is not limited to those. For example, as long as an operation article has an essential portion of the present invention, no matter how it is conducted, it cannot be overemphasized that it belongs to the scope of right of the present invention.

What is claimed is:

1. A gaming display comprising:
a light guide plate having at least two flat surfaces; and
a light emit member for emitting light to the light guide plates,
wherein the light guide plate is sectioned by a groove for avoiding interference of light from the light emit member.

2. The gaming display of claim 1, wherein the gaming display is configured by stacking at least two light guide plates.

3. The gaming display of claim 2, wherein the gaming display is arranged to light up a selected light guide plate.

4. The gaming display of claim 3, wherein a character or a number is written on the light guide plate, wherein the character or the number within a range where light from the light emit member is guided is arranged to appears, and wherein the character or the number written on each of the light guide plate is difference from each other.

5. The gaming display of claim 3, wherein a picture is written on the light guide plate, wherein the picture appears within a range where the light from the light emit member is guided is arranged to appear, and wherein the picture written on each of the light guide plate is difference from each other.

6. The gaming display of claim 1, wherein a plurality of characters or numbers is written on the light guide plate by different materials from each other so that the characters or the numbers appearing within range where the light is guided change according to a kind of emitted light from the light emit member.

7. The gaming display of claim 1, wherein the flat surface onto which emitted light is irradiated is roughened.

8. The gaming display of claim 1, wherein the light emit member is a light-emitting diode.

9. A gaming display comprising:
a light guide plate having at least two flat surfaces; and
a light emit member for emitting light to the light guide plates,
wherein the light guide plate is sectioned by a light shielding member for blocking light to enter another section of the light guide plate.

10. The gaming display of claim 9, wherein the light emit member is arranged to emit light to a selected light guide plate.

11. The gaming display of claim 10, wherein the light emit member is placed around the light guide plate.

12. The gaming display of claim 10, wherein the light guide plate has a space in the middle of the guide plate and the light emit member is placed in the space.

13. The gaming display of claim 10, wherein the gaming display has a plurality of light emit members and a light emit member of the plurality of the light emit members sequentially emits light to indicate a selected section of the light guide plate by moving a position from which light is emitted across the plurality of light emit members.

14. The gaming display of claim 10, wherein the light emit member emits light to indicate a selected light guide plate by rotating the light guide plate.

15. The gaming display of claim 9, wherein the light emit member is a light-emitting diode.

16. The gaming display of claim 9, wherein the light guide plate is a light guide wheel.

17. A gaming display employing a substrate including a light guide element, comprising:
a plurality of areas provided on the substrate, which has at least one surface;
a light shielding member or a space between the areas; and
a code, a character or a number drawn in the area.

18. The gaming display of claim 17, wherein the substrate is a wheel.

19. The gaming display of claim 18, wherein the gaming display has a tool for indicating a selected area of the plurality of areas.

20. The gaming display of claim 18, wherein the gaming display is utilized on a bonus game or a secondary game.
